(19) United States
(12) Patent Application Publication
(10) Pub. No.: US 2004/0163112 A1
(43) Pub. Date: Aug. 19, 2004

(54) Data signal receiver programmed by loading program and method for updating software using loading program

(75) Inventors: Krzysztof Matula, Katowice (PL); Jakub Skibinski, Zielona Gora (PL)

Correspondence Address: HOFFMANN & BARON, LLP, 6900 JERICHO TURNPIKE, SYOSSET, NY, 11791, US

(73) Assignees: Advanced Digital Broadcast Polska Sp. z o.o.; Advanced Digital Broadcast Ltd.

(21) Appl. No.: 10/775,671

(22) Filed: Feb. 10, 2004

(30) Foreign Application Priority Data
Feb. 14, 2003 (PL) P-358733

(51) Int. Cl. G06F 3/00

(52) U.S. Cl. 725/50

(57) ABSTRACT

A data signal receiver has a processor and interfaces, RAM, ROM, NV-RAM and non-volatile memory linked to the processor. A decompressing program of a loader and the loader in a compressed form is stored in the non-volatile memory and after being decompressed, by the decompressing program, the loader is stored in a section of the RAM memory, the section being declared as ROM memory. The loader is a program receiving a data signal receiver's code from external sources and exchanges it in the data signal receiver, storing it in the data signal receiver's non-volatile type memory. The loader does not reproduce audio or video signals, but is able to communicate with a user by displaying information on the screen, in order to show a state of current updating of the data signal receiver's software code.

### CROSS-REFERENCE TO RELATED APPLICATIONS

This application claims priority to Polish Application No. P-358733, filed Feb. 14, 2003, the contents of which are incorporated herein by reference.

### BACKGROUND OF THE INVENTION

1. Field of the Invention

The present invention relates to a data signal receiver, programmed by a loading program and a method for updating software using the loading program used, for instance, in cellular telephones, in radio and television receivers, and especially in digital television decoders.

1. Brief Description of the Background of the Invention Including Prior Art

The procedure of updating the software is serviced by a loading program, from here on called Loader. It processes data packets, received by the device, and creates a program, which is stored in the device's FLASH memory.

The prior art includes a project named EUROLOADER, containing the specifications of a digital television decoder loader, accepted by companies united in the European Cable Communication Association (ECCA). This project describes the functioning of the loader, defining the procedure of software updating in decoders. According to the specifications, data, concerning the software updating, are transmitted frequently in order to avoid update delays. The applications were here separated into the EUROLOADER program, and the operational program (application). The EUROLOADER program is further divided into two parts: the starter code, and the loader code. Specifications of the EUROLOADER program require the device to be equipped with at least four types of memory: RAM, FLASH, ROM, and NV-RAM. The RAM memory stores temporary information. The FLASH memory contains the application code, with a possibility of existing to update the data stored in the FLASH memory. The ROM memory, in turn, contains data that is not subject to updating, in that, a part of the EUROLOADER program code, in the form of the starter code. The NV-RAM memory is reserved mostly for information concerning the configuration of the device.

The prior art, commonly known from PC computers, also contains programs used for executable files compression. They are used to compress programs, based on the known solution of self-extracting archives, which initiate an appropriate program, after decompressing files onto the disc.

### SUMMARY OF THE INVENTION

Purposes of the Invention

It is an object of this invention to provide a data signal receiver, programmed by a loading program stored in smaller memory as compared to known receivers.

It is another object of this invention to provide a method for updating software using the loading program stored in smaller memory as compared to known receivers.

These and other objects and advantages of the present invention will become apparent from the detailed description, which follows.

Brief Description of the Invention

A data signal receiver, programmed with the loader, contains: a signal reception block, a processor, interfaces, RAM, ROM, and NV-RAM memory, as well as non-volatile memory. The processor contains an internal block initiating the loader, as well as blocks servicing the loader, which—based on a code initiated by the initiating block—manages the loader. The loader is stored compressed in the non-volatile memory, and after being decompressed it is stored in the section of RAM memory, segment declared as ROM memory.

A method for updating software in a data signal receiver having a processor and interfaces, RAM, ROM, NV-RAM and non-volatile memory linked to the processor includes the steps of: storing of updated software containing a loader in a compressed form in the non-volatile RAM memory and copying a start procedure, while initiating, at a permanent address in a section of the RAM memory, declared as ROM type memory prior to a connection process.

The loader's start procedure can be initiated upon connecting the receiver to a power source, at the user's request, or through an outside signal, transmitted to the receiver.

The decompressed loader code is located at a permanent address in the RAM memory.

The memory image can be created from the section containing the loader's booting sequence, the section containing the loader's jump table, as well as the section containing the segment with the loader's static data and its code. It is then stored in non-volatile memory in a compressed form.

The loader's jump table can contain addresses of functions common to the decompressing program and the loader. These functions are defined in the decompressing program.

The novel features, which are considered as characteristic for the invention, are set forth in the appended claims. The invention itself, however, both as to its construction and its method of operation, together with additional objects and advantages thereof, will be best understood from the following description of specific embodiments, when read in connection with the accompanying drawings.

### BRIEF DESCRIPTION OF THE DRAWINGS

In the accompanying drawings one of the possible embodiments of the present invention is shown, where

FIG. 1A is a simplified view of the digital television decoder;

FIG. 1B is a simplified view of a cellular telephone receiver;

FIG. 2 shows a structure of a FLASH memory;

FIG. 3A is a flow chart of a function initiating an uncompressed loader;

FIG. 3B is a flow chart of a function initiating a compressed loader;

FIG. 4 shows a structure of a RAM memory organized for the compressed loader;

FIG. 5 is a flow chart of a procedure for creating a compressed memory image;

FIG. 6 is a flow chart of a diagram showing the functioning procedure of the program decompressing the loader; and

FIG. 7 is a loader's jump table.

### DESCRIPTION OF INVENTION AND PREFERRED EMBODIMENT

The presented method may be applied for different types of signal receivers. The digital television receiver was shown here solely as an example. The mentioned receivers may include cellular telephones, palmtops, radio receivers, and all sorts of other devices in which exists the possibility of updating software through external signals received by them.

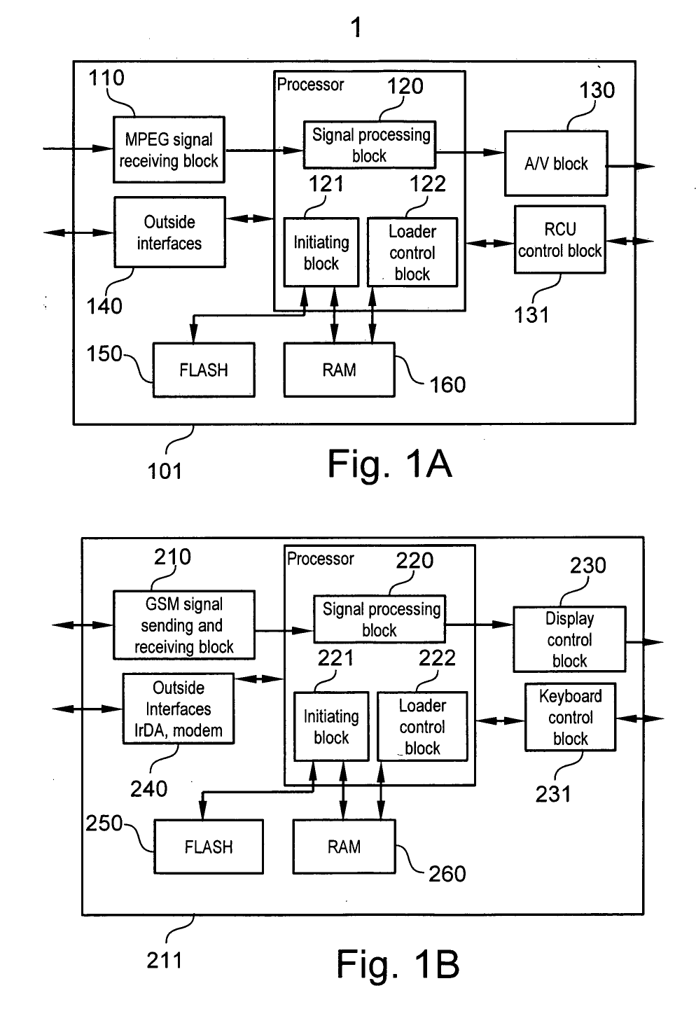

FIG. 1 A gives a simplified view of a television signal receiver. It is a digital television decoder 101. The main component of the digital television decoder 101, is the processor, which manages the receiver functions. The processor contains a signal processing block 120, an integral initiating block 121, which initiates the loader, as well as the block servicing the loader 122, which controls the loader using the code initiated by the initiating block 121. A signal from the MPEG signal receiving block 110 is sent to the processor. The processor is additionally capable of bi-directional data exchange, through external interfaces 140. Exchanging the data with a remote control unit 131 is also possible, as is the sending of an audio/video signal to a receiver (for example a television receiver). The digital television decoder also contains various types of memory, bi-directionally connected to the processor. These are the FLASH 150, and RAM 160 memories. These memories store the programs controlling the digital television decoder functions, including the compressed loader, which stores a method for controlling the non-volatile memory, for instance the Flash type memory 150, or the decoder's RAM type memory 160. The loader is a program receiving the decoder's code from outside sources and exchanges it in the digital television decoder, storing it in the digital television decoder's FLASH type memory 150. The loader does not reproduce audio or video signals, but is able to communicate with the user of the device, by displaying information on the screen, in order to show the state of the current updating of the decoder's software code.

Cellular telephones 211 are another type of a receiver that the present invention may be applied to. Such a telephone receiver is shown in FIG. 1B. The integral components 202, 221, and 222 of the processor, perform the same functions as in case of the television decoder in FIG. 1A. The same is the case with the memory 250, and 260. The components responsible for communicating with the data source, and with the user do, however, change. The first group of circuits includes the GSM signal transmitting/receiving block 210, and the external interface (for example IrDA) block 240. The second group of circuits includes the block controlling the telephone receiver display 230, and the block controlling the keyboard 231. Similar differences, clearly apparent to one skilled in the art, can be found in other similar devices, to which, the method described in this invention, can be applied.

The code, which is stored in the digital television decoder, is divided into two parts: The decoder code, and the loader code. The decoder code—also called the high level code, or the application—is responsible for receiving, decoding, and displaying the audio signals, the video signals, and other components, such as teletext, or subtitles in various languages. The loader may be initiated each time, when the digital television decoder is being connected to the power source. After being initiated, the loader checks the possible application sources. If a possibility of updating the application through the decoder's external interfaces 140 exists, the loader checks the possibility of a new update, and if it is possible, the application exchange begins. If there exists a possibility to exchange applications, using signals broadcasted in the satellite, cable, or terrestrial television signals, received by the signal receiving block 110, the loader sets itself on an appropriate data stream, utilizing parameters stored in the NV-RAM memory. The loader initiates the application update procedure by checking, if the program currently broadcasted is meant for the digital television decoder, in which the loader has been initiated. If that is the case, the updating procedure is accepted.

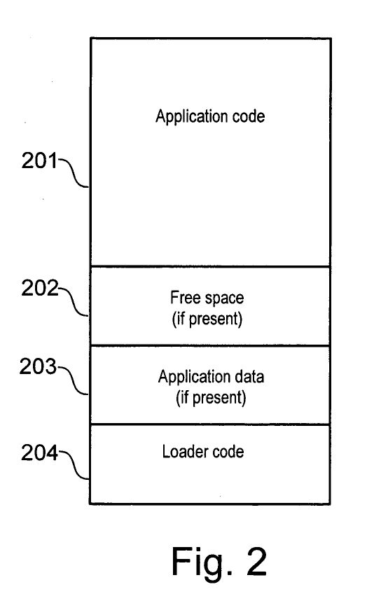

The loader may also be initiated on user demand, or activated by a specified signal from the broadcaster. The broadcaster may transmit a signal informing about a new version of the software being available. Upon receiving this information, a user may put forth a request to initiate the loader. The loader may also be initiated automatically. The signal in question may also contain additional information specifying the source, or the type of transmitted data. Both the application code as well as the loader code, are stored in the FLASH memory 150, available in the digital television decoder. FIG. 2 shows the layout of the FLASH memory of the decoder shown in FIG. 1A. The FLASH memory is divided into four parts. The first part 201 contains the decoder software. The second 202, is the free memory segment—if free memory is available. The next part 203 contains optional application data, and the last part 204, is the loader code. The memory segment, available to the loader code, usually equals 128 kilobytes. Upon the start of the loader, its entire code is copied into the RAM memory 160, available in the digital television decoder.

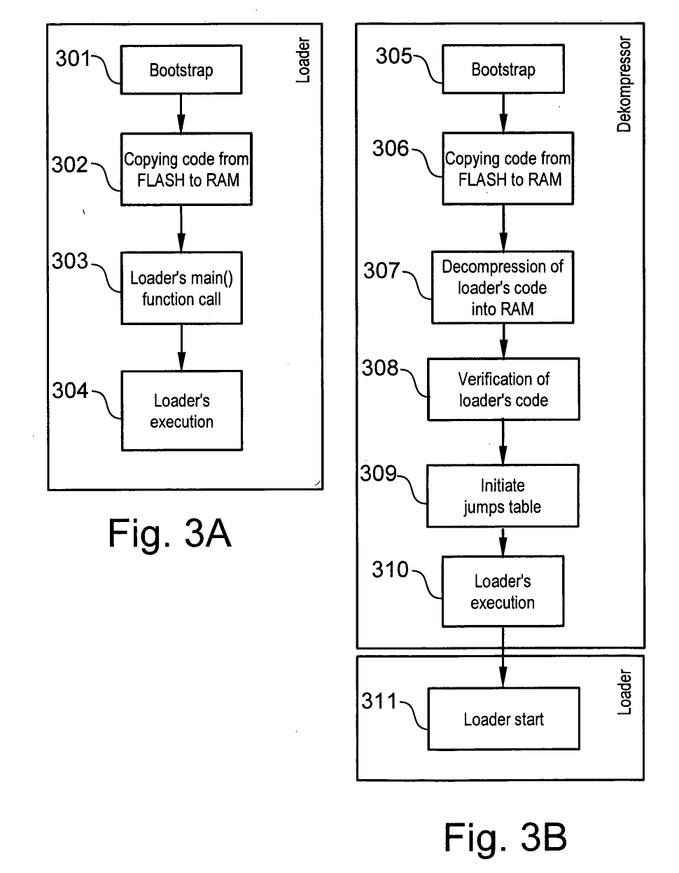

FIG. 3A shows a flow diagram of initiating the loader. The starting program is initiated in step 301. The starting program begins to function immediately upon switching the digital television receiver on, or following the return to the system's initial settings (reset). An option exists for the procedure to initiate the FLASH memory—depending on the configuration—and/or to check the state of the digital television decoder, in order to establish, for instance, whether to initiate the loader or the application program. The initiation part takes place in step 302. It depends on the decoder's hardware configuration. Here, as an example, the program code is copied from FLASH memory to RAM memory. The main function, initiating the loader, is invoked in step 303. The loader is executed in step 304.

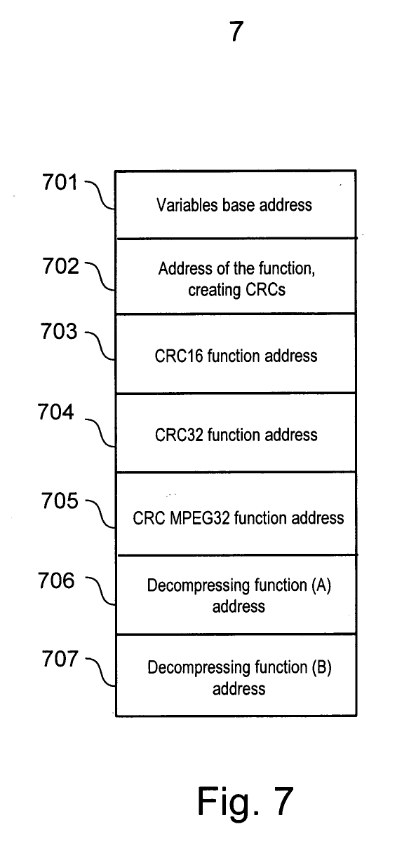

FIG. 3B shows the flow chart of a diagram of a procedure for initiating the compressed loader applicable above all in complex configurations. In some configurations the loader code size is too large to fit in the common 128 kilobytes modules of FLASH memory 150. In order to decrease the loader's program size, its code is compressed. The introduction of the compression of the loader code results in more memory being available, for instance, for the drivers of the individual components of the digital television decoder, such as the modulator, or the tuner. In this case the loader code comprises: the actual loader application, and the decompressing module (restoring the loader code's original structure), which extracts the proper loader code to the RAM memory 160, available in the digital television decoder. The procedure of initiating the program compressed in this manner is divided into two parts. The first part, comprising the steps 305, 306, 307, 308, 309, and 310, is serviced by the decompressing program. The second part, comprising the step 311, is serviced by the loader. The starting program is initiated in step 305. It is initiated upon switching the digital television decoder on, or following the return to the system's initial settings (restart). In step 306, the code is copied from the FLASH memory, to the RAM memory. In step 307 the program is decompressed (extracted, restored to the code's original form) to the digital television decoder's RAM memory. The decompressed code—the code in its original form—is verified in step 308. Next, in step 309, the jump table, which is presented in FIG. 7, is initiated. The main function, initiating the loader, is invoked in step 310. The loader is initiated in step 311.

Uncompressed loaders may be located in any available memory segment. In the case of the compressed loader, permanent memory addresses are used, in order to assure proper references to locations containing variables, constants or pointers to functions. That is why it is additionally assumed, that the decompressed loader code is located at a permanent address in the RAM memory. In order to protect against a linker (a linking program) adding procedures—which are typically attached, when the program is placed into RAM memory—it is necessary to inform the linker that the segments, reserved for the loader, are ROM memory. During the linking of procedures by the linker, all modules of the given program are collected, and the information regarding the references between individual modules is brought up to date. Ultimate addresses are also assigned to functions and data, which were not assigned them during the stage of program compiling and generating the result program. Servicing the compressed loader requires a special approach to the operation of placing the programs and their data in FLASH memory. It is assumed that addresses in the RAM memory begin with the address OxC0000000, and that the amount of memory equals eight megabytes. The amount of FLASH memory equals four megabytes. Increasing the amount of available RAM memory causes an increase in the amount of available memory in the general use segments. Addresses of the remaining segments are permanent.

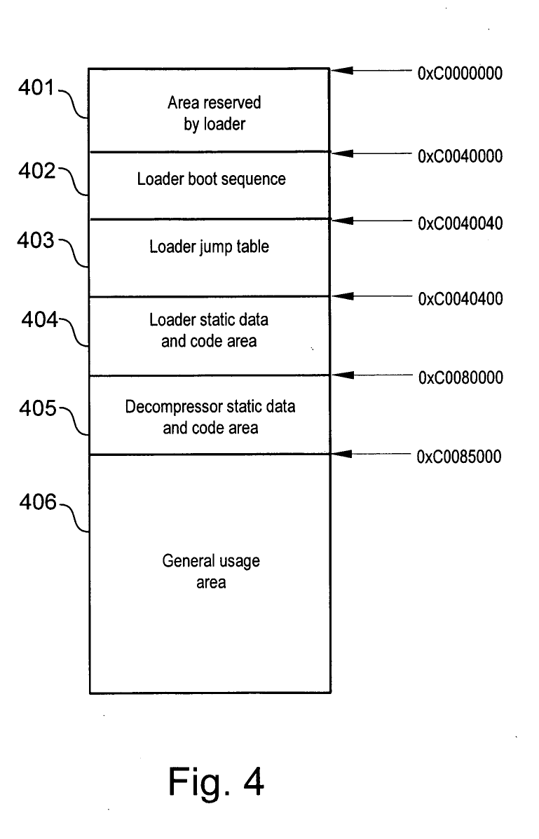

FIG. 4 shows the detailed organization (layout) of the RAM memory. Block 401 represents the segment or section reserved by the loader—that is, the segment of memory, reserved for the OSGL (On Screen Graphic for Loader) driver, responsible for displaying graphic elements in the receiver screen, and the DMUX (DeMUltipleXer submodule) driver—controlling the filtration of data arriving at the digital television driver, which are intended for the loader. Block 402 represents the loader's starting sequence. It is a memory segment containing the starter block code. The address of the first byte from the segment 402 (OxCO040000) constitutes the starting point for the loader. Block 403 represents the segment of memory reserved by the loader's jump table for functions common to the loader and the decompressing module (restoring the code's original form). Block 404 represents the memory segment, utilized by the loader code after decompression and by the loader's static data, for instance, constants and static variables. Block 405 represents the range of memory, utilized by the decompressing program's code, and by the decompressing program's static data, for instance, constants and static variables. Block 406 represents the general-purpose segment, reserved in the memory. Segment 406 represents the range of addresses, intended for both the decompressing program's data—including the compressed loader code—and the loader module code. Using a compressed loader in digital television decoders requires carrying out a procedure of creating a RAM memory image. In order to carry out this procedure, two files, containing the memory image, are created after compilation and linking. In some systems, these files have the extension “.hex”. The first file contains the loader's start sequence, located in block 402. The second file is a memory segment containing the loader's static data and its code. It is located in block 404. Blocks 402, and 404 are used to create the RAM memory image.

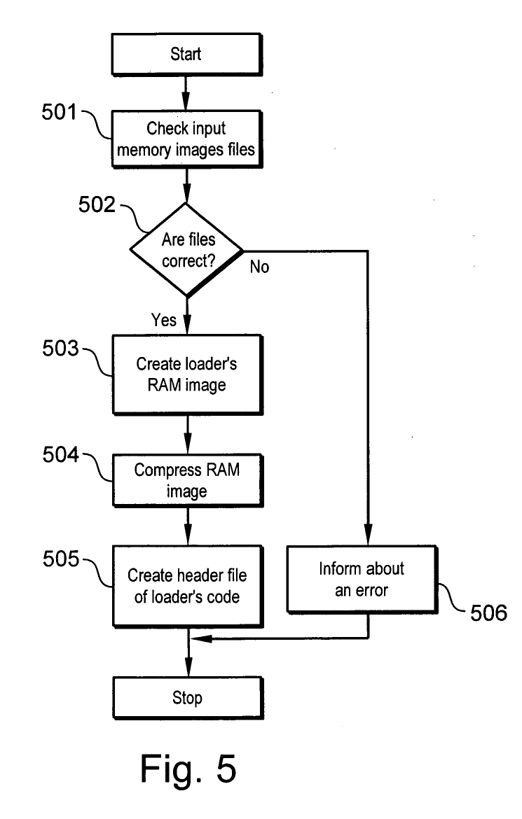

FIG. 5 is a flow diagram showing the procedure creating the compressed memory image. After the start, in step 501, the files containing the memory image are read. In step 502, the input files are compared with the memory image, meaning that a check is conducted to determine whether the loader's static data and code are in the correct addresses. If the files are not in order, error information is displayed in step 506, and the procedure is finished. If the files match the formats, the RAM memory image is created in step 503. This image constitutes a bytes table, comprising in order, from memory segments 402, 403, and 404. While creating the RAM memory image, the segment 403 is filled with zeros. The memory image is compressed in step 504. In step 505, the loader's header file is created, comprising the compressed RAM memory image and information necessary for proper decompression. The loader code is placed in RAM memory.

The loader's header file contains the following decompressing module options:

loader₁₃area₁₃start₁₃addr—address to the location in memory, where the loader's start sequence begins—block 401;

loader₁₃area₁₃size—a variable defining the size of the block available to the loader;

loader₁₃code₁₃size—a variable defining the size of the code after compression;

compressed₁₃loader₁₃crc—checksum of the compressed loader code;

loader₁₃compression—the chosen compression type;

original₁₃code₁₃addr—address of the decompressed loader code—block 404

original₁₃code₁₃size—size of the loader code, prior to compression;

original₁₃code₁₃crc—checksum of the loader code, prior to compression.

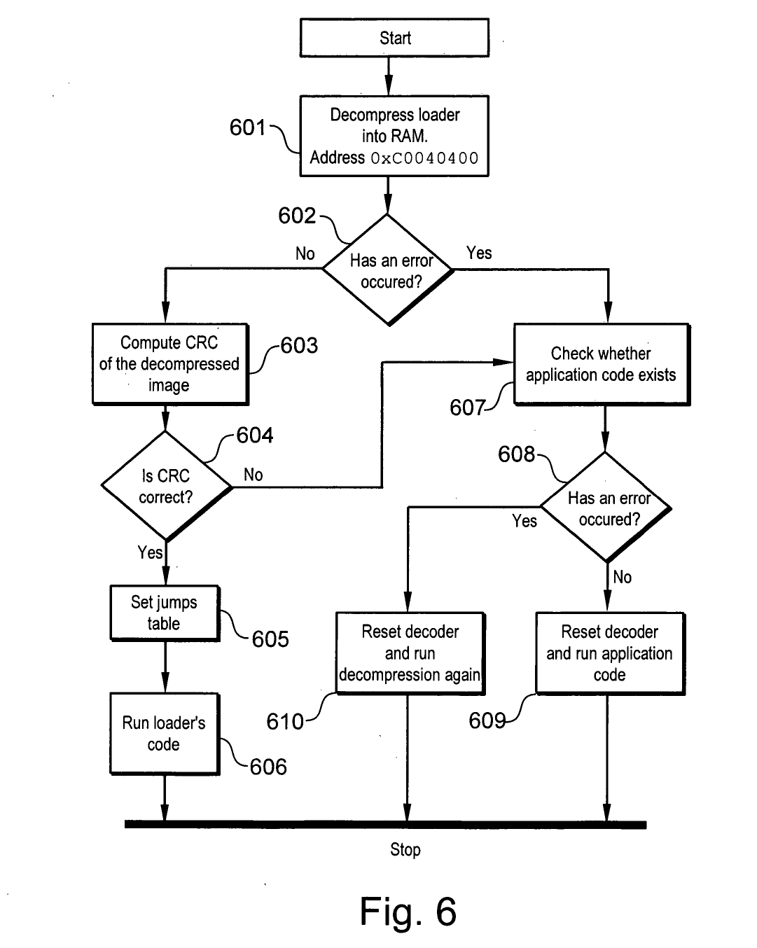

FIG. 6 is a flow chart of a diagram showing the functioning procedure of the program decompressing the loader. The loader header file is used by the decompressing program module, a part of which it constitutes. In step 601, the loader code is decompressed into the RAM memory, under the address OxC0040400. A check is conducted in step 602, to determine, whether any errors occurred during the code's decompression. If an error is detected, the procedure moves on to step 607. If no errors are found, the decompressed loader's checksum CRC is calculated in step 603. Next follows step 604, where a check is conducted to determine, whether the checksum CRC is correct. If the checksum is incorrect, the procedure moves on to step 607. In the case the checksum is correct, the procedure first moves on to step 605, where the decompressing program initiates the loader's jump table (shown in FIG. 7), and then to step 606. Initiating the jump table is a part of the decompressing process, and is achieved by filling the jump table with appropriate addresses. In step 607, the procedure checks whether the application code is correct, and then, in step 608, checks for errors. If no errors are detected, initial settings are set in the digital television decoder, in step 609, and the procedure ends, initializing the application. If an error occurs, the procedure follows to step 610, where is sets the initial settings in the decoder. Checksums for the memory images are calculated before and after compression, so that the decompressing program can verify the loader code prior to compression, and after decompression.

FIG. 7 shows the loader's jump table. The table is a set of addresses, of which each uses four bytes of memory. The table begins with the base address 701 of global static variables. The subsequent addresses are: address 702 of the function initiating the table used to calculate the checksum CRC, address 703 of the function calculating the checksum CRC 16, address 704 of the function calculating the checksum CRC 32, address 705 of the function calculating the checksum CRC MPEG32, address 706 of function A used to decompress the loader, and address 707 of function B used to decompress update data. The existence of two decompressing function is due to the fact, that the loader may be compressed using a different compression method than the received update data.

The use of the compressed loading program allows the possibility of utilizing a larger number of drivers, and decreasing the required amount of non-volatile memory—for instance the FLASH memory—which, when kilobyte prices are compared, are more expensive than the RAM memory. As opposed to solutions, familiar from PC computers, applying compression in devices lacking a hard drive is considerably harder. This is due to the necessity of creating an appropriate RAM memory structure, and utilizing this structure. Moreover, this solution makes use of memory images instead of executables, as is done in present technology.

The preferred embodiments having been thus described, it will now be evident to those skilled in the art, that further variation thereto may be contemplated. Such variations are not to be regarded as a departure from the invention, the true scope of the invention being set forth in the claims appended hereto.

What is claimed is:

1. A data signal receiver programmed with a loader comprising:
(a) a processor containing
a signal processing block,
an initiating block initiating the loader, and
a loader control block servicing the loader based on a code initiated by the initiating block;
(b) signal-receiving block;
(c) interfaces linked to the processor;
(d) RAM, ROM, and NV-RAM memory linked to the processor; and
(e) non-volatile memory linked to the processor, wherein a decompressing program of the loader and the loader in a compressed form are stored in the non-volatile memory and after being decompressed, by the decompressing program, the loader is stored in a section of the RAM memory, the section being declared as ROM memory.

2. The data signal receiver according to claim 1 wherein the signal processing block is connected to the data source through a GSM signal transmitting/receiving block and/or an external interface block.

3. The data signal receiver according to claim 1 wherein an memory image is created from a section containing a loader's booting sequence, a section containing a loader's jump table and a section containing a segment with loader's static data and loader's code wherein the memory image is stored in non-volatile memory in a compressed form.

4. The data signal receiver according to claim 3 wherein the loader's jump table contains addresses of functions common to a decompressing program and the loader, the functions are defined in the decompressing program.

5. The data signal receiver according to claim 1 wherein the loader's code after decompressing is located at a permanent address in the RAM memory.

6. The data signal receiver according to claim 1 wherein the non-volatile memory is FLASH memory.

7. A method for updating software in a data signal receiver having a processor and interfaces, RAM, ROM, NV-RAM and non-volatile memory linked to the processor comprising:
storing of software containing a loader in a compressed form in the non-volatile RAM memory; and
upon initiating startup procedure, copying the software to a permanent address in a section of the RAM memory, declared as ROM type memory prior to a software linking process.

8. The method for updating software according to claim 7 wherein a startup procedure of the loader is executed upon connecting the data signal receiver to a power source.

9. The method for updating software according to claim 7 wherein a startup procedure of the loader is initiated at a user's request.

10. The method for updating software according to claim 7 wherein a startup procedure of the loader is initiated by an external signal, transmitted to the data signal receiver.

11. The method for updating software according to claim 7 wherein a memory image is created from a section containing a starting sequence of the loader, a section containing of a jump table of the loader and a section containing area with static data of the loader and its code and then the memory image is stored in non-volatile memory in a compressed form.

12. The method for updating software according to claim 7 further comprising creating a jump table of the loader, the jump table containing addresses of functions common to the decompressing program and the loader, defined in the decompressing program.

13. The method for updating software according to claim 7 further comprising
checking whether a software currently broadcasted in the data signal is meant for the data signal receiver, in which the loader has been initiated after initiating an application update procedure; and
accepting the application update procedure when the program currently broadcasted in the data signal is meant for the data signal receiver, in which the loader has been initiated.
